(19) United States
(12) Patent Application Publication
(10) Pub. No.: US 2012/0080458 A1
(43) Pub. Date: Apr. 5, 2012

(54) Hangers

(76) Inventor: Stuart Kimpton, Buckingham (GB)

(21) Appl. No.: 12/898,635

(22) Filed: Oct. 5, 2010

(51) Int. Cl. A47G 25/14; B29C 51/10; B29C 51/26; B29C 51/00

(52) U.S. Cl. 223/85; 264/330; 264/101; 264/86

(57) ABSTRACT

A molded garment hanger (10, 110) having the form of a generally planar unitary item with a hook (14, 114) or eye integral with a pair of hanger arms (12, 112), said hanger being composed of a single constituent material that is either bagasse or empty palm tree fruit bunches (EFB) that has been subjected to wet process thermoforming by which the material's moisture content is removed (e.g. extracted and/or expressed) whilst the material is subjected to a molding pressure and is being dried, said process providing the molded hanger as a lightweight mono-layer construction, i.e. with an overall weight less than 45 g (preferably of the order of 25 g to 35 g), with a mono-layer thickness less than 1.5 mm (preferably in the range 1 mm to 1.5 mm), and such as to be rapidly biodegradable, i.e. to be capable of total bio-degradation by composting in less than 12 weeks.

### BACKGROUND OF THE INVENTION

1. Technical Field

This invention relates to garment hangers and in particular to garment hangers composed of biodegradable material.

2. Background

Biodegradable hangers are known from, for example, U.S. Design Pat. D-548982-S, US Patent Publication US-2006/0065681, U.S. Pat. No. 7,198,182, and JP-9037921. Such biodegradable garment hangers are increasingly being used by dry-cleaning establishments in addition to smaller scale domestic use by individuals concerned with environmental issues. Unfortunately many known garment hangers are made of waste board, card, paper (alone or with other constituents) that has been reconstituted. They are insufficiently sturdy to support weighty garments unless they are fabricated as a multi-layer laminate—which results in a heavy product. Furthermore their quality is too variable in that the start-material for their manufacture comprises a mixture of waste material of varying consistency and the hangers produced therefrom often cannot conform to composting regulations such as DIN CERTCO 13432.

It is therefore considered desirable to provide a lightweight garment hanger of non-laminated construction that is rapidly biodegradable. As used herein, the term “lightweight” means a hanger with a weight no greater than 45 g and the term “rapidly biodegradable” means capable of total biodegradation by composting in 12 weeks or less.

### SUMMARY OF THE INVENTION

According to one aspect of this invention there is provided a lightweight and rapidly biodegradable molded garment hanger having the form of a generally planar mono-layer item with a hanging element, e.g. a hook or eye, integral with a pair of hanger arms, said hanger being composed of a single constituent material that is either bagasse or empty palm tree fruit bunches (EFB) that has been subjected to wet process thermoforming by which the material's moisture content is removed (e.g. extracted and/or expressed) whilst the material is subjected to a molding pressure and being dried, said process providing the molded hanger as a mono-layer with a lightweight construction with a thickness less than 1.5 mm.

Preferably said mono-layer thickness is in the range 1 mm to 1.5 mm.

Advantageously the overall weight of the hanger is of the order of 25 g to 35 g.

Preferably the garment hanger includes an integral deformation providing a re-inforcing ridge adjacent to the perimeter of the finished hanger.

Advantageously the deformation permits stacking of a plurality of said hangers one upon the other in mutual surfacial abutment.

Preferably the garment hanger is devoid of any re-inforcing or protective coating detracting from its compostability.

According to another aspect of this invention there is provided a method of manufacturing a lightweight and rapidly biodegradable garment hanger wherein a body of either bagasse material or empty palm tree fruit bunches (EFB) material is placed in a mold having a cavity in the form of a hanger with a hanging element, e.g. a hook or eye, integral with a pair of hanger arms and generally coplanar therewith, and wherein said material is subjected to wet process thermoforming by which the material's moisture content is removed (e.g. extracted and/or expressed) whilst the material is subjected to a molding pressure and being dried, to provide the resultant a mono-layer molding as a lightweight and rapidly biodegradable hanger with an overall thickness less than 1.5 mm.

Preferably said thickness is in the range 1 mm to 1.5 mm—advantageously 1.1 mm.

Preferably said overall weight is of the order of 25 g to 35 g.

Advantageously the body of bagasse or EFB material initially comprises water and pulp mixture in the ratio of 99.5% water and 0.5% pulp.

The initial temperature of the water may be between 30° C. and 50° C., preferably approximately 40° C.

Advantageously the pressure applied to the material in the mold is between 3.5 Kg/cm (50 psi) and 10.6 Kg/cm (150 psi).

Preferably the molding temperature is in the range of 250° C. to 300° C. approximately.

Advantageously water is extracted from the mold by a vacuum, e.g. a vacuum between 610 mmHg and 710 mmHg.

In a preferred embodiment the mold is provided with mating parts comprising at least one depression and projection to produce an elongate deformation adjacent to the perimeter of the finished hanger, which deformation serves as an integral reinforcing ridge. Advantageously the reinforcing ridge extends continuously around the perimeter of the finished hanger.

The mold may comprise a foraminous wall (e.g. a wall of fine mesh material) through which said moisture content is expressed.

### BRIEF DESCRIPTION OF THE DRAWINGS

By way of example embodiments of this invention will now be described with reference to the accompanying drawings of which:

FIG. 1 is a front elevation of a garment hanger according to the first embodiment of the invention,

FIG. 2 is an underneath plan view in the direction of the arrow II of FIG. 1;

FIG. 3 is a cross-sectional view along the line III-III of FIG. 1;

FIG. 4 is a front perspective view of a garment hanger according to a second embodiment of this invention;

FIG. 5 is front elevational view of the garment hanger of FIG. 4;

FIG. 6 is a cross-sectional view along the line VI-VI of FIG. 5;

FIG. 7 is an underneath plan view in the direction of arrow VII of FIG. 5;

FIG. 8 is a cross-sectional view along the line VIII-VIII of FIG. 5;

FIG. 9 is a cross-sectional view along the line IX-IX of FIG. 5; and

FIG. 10 is a cross-sectional view along the line X-X of FIG. 5.

### DETAILED DESCRIPTION OF EXAMPLE(S) OF THE INVENTION

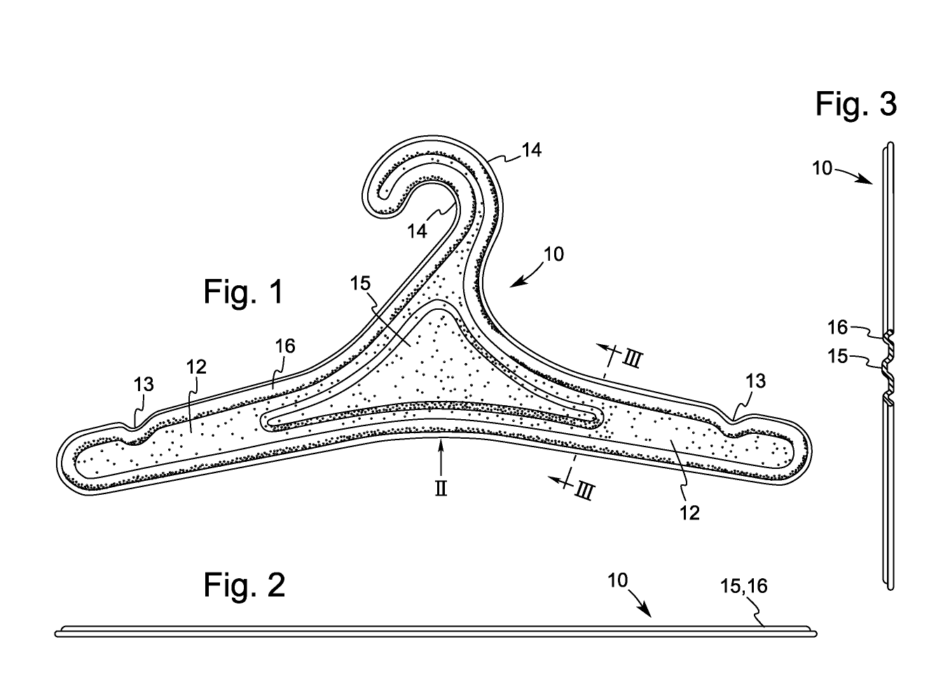

The illustrated garment hanger 10 of FIGS. 1 to 3 has a pair of arms 12 extending from a central, generally triangular zone 15 from which a hook 14 extends upwardly to constitute a hanging element for the hanger. The upper edge of the arms 12 are provided with indents 13 that can receive loops or straps of garments to be hung from the hanger. The entire hanger 10, including arms 12 and hook 14, is manufactured as an integral one-piece item from a biodegradable biomass material consisting of bleached bagasse pulp derived from sugar cane waste. The start material has a sheet formation with pulp sheet moisture content of 10-12% and a thickness of 0.75 mm. Ideally the sheet has a brightness weight of 80% ISO minimum and a TAAPI count less than 10 ppm.

The chemical bleached bagasse pulp is made from well depithed fresh bagasse obtained from a That sugar mill. The pulp is elemental chlorine free (ECF) obtained from empty fruit bunches (EFC) and contains soda which gives the product outstanding inherent properties of smoothness, stiffness, opacity and bulkiness and in addition requires less energy to meet desired drainage and strength. The bagasse pulp employed is a product that is manufactured in a totally environmentally aware manner from a renewable resource to provide an end product that is 100% recyclable, 100% biodegradable and 100% compostable. The pulp product employed is certified against DIN CERTCO (DIN EN 13432) standard which defines requirements for materials recoverable through composting and biodegradation

For use in preparing the material for the wet process thermoform process, the biomass pulp is blended together with water at 40° C. to form a water/pulp mixture in the ratio of 99.5% water and 0.5% pulp. The lower section of a mold has a hanger-shaped cavity with a foraminous lower wall, e.g. made from a fine mesh, and this is immersed into the mixture which fills the mold cavity. The mold's lower section, with or without the mold's upper section thereon, is then removed from immersion, and a vacuum suction is then applied to remove the water through the mold's foraminous wall (of fine mesh).

The vacuum applied is between approximately 610 mmHg to 710 mmHg (maximum)) to leave only a layer of moist pulp in the mold cavity. With the upper section of the mold located matingly upon the lower section, the pulp mixture in the mold is compressed under heat and pressure to the form of the hanger-shaped cavity of the mold. In the preferred form of this embodiment the molding temperature is between 250° and 300° C., and the molding pressure is between 3.5 kg/cm (50 psi) to 10.6 Kg/cm (150 psi) to leave a formed hanger as a mono-layer with a material thickness of less than 1.5 mm (preferably a material thickness between 1 mm and 1.5 mm) and with an overall weight less than 45 g (preferably between 25 g and 35 g). Advantageously the pulp mixture remains in the mold for a molding time of between 5 to 30 seconds, the molded product being then ejected. A die cutting machine provides a neat final outline for the finished hanger 10.

It will be apparent that in the above-described wet thermoforming process the material's moisture content is simultaneously vacuum extracted and pressure expressed from the foraminous mold whilst that mold is subjected to heating and the material therein is being dried. It should be noted that this wet thermoforming process, by using the simultaneous application of heat and pressure, enables the fibers of the start material to be remolded whilst they are still wet thereby permitting substantial strength to be obtained even with a mono-layer thickness of, say, 1.1 mm. This wet thermoforming process thus differs from the ‘dry’ process where a lower mold section is immersed into the pulp, a vacuum is applied to extract the moisture, the mold is conveyed through a line of heaters and, after the material in the mold is substantially dry, the upper mold section is applied under pressure to compress the dry pulp into shape. This pressure application to dried fibres “re-organizes” them and leads to a weaker end product. The wet thermoforming process also differs from other techniques for manufacturing disposable products in that, with embodiments of the present invention, there are no additives (e.g. buffers, colorants) to the start-material which in the prior art is usually a pre-used product such as the waste paper, newspaper, magazines, corrugated cardboard or discarded documents commonly recycled for use in manufacturing prior art biodegradable products.

The resultant biodegradable garment hanger 10 formed from the bio-mass start material specified, with the resultant weight and material mono-layer thickness, renders the hanger lightweight and rapidly biodegradable (each as previously defined). Due to the co-operating parts of the mold, the resultant lightweight rapidly biodegradable hanger:

incorporates an integral ridge 16 which follows the perimeter of the hanger but is spaced approximately 2 to 3 mm from the edge, and also incorporates a raised, centrally-located, generally triangular promontory defining the zone 15 with a similar height to that of the ridge 16.

The ridge 16 and promontory 15 permit stacking of a plurality of hangers 10 in surfacial abutment one upon the other.

It will be apparent that this contouring of, in particular, ridge 16 and promontory 15 is achieved by molding/forming the hanger 10 using the above described ‘wet’ process. The ridge 16 and promontory 15 aid in providing an optimum strength to thickness ratio for the finished hanger 10 and it is considered that a biodegradable paper hanger of similar 1 mm thickness could not offer this degree of strength.

In addition, the resultant lightweight hanger 10 (with a preferred weight of approximately 25 to 35 g) is of the order of 10% to 15% lighter than a traditional wire hanger and is approximately 250% to 300% lighter than a conventional recycled paper hanger. Being formed with round edges (see drawings), it does not tear or ‘catch’ on the material of garments hung from the hanger. The biomass composition of hanger 10 allows it to be used with existing dry cleaning accessories and on dry cleaning carousels. For example it is sufficiently moisture resistant such that a wet shirt can be hung from it without any functional deterioration. Furthermore the hanger 10 is considered strong enough to lift up to 4 Kg from its hanging element formed by hook 14.

It will be apparent that other kinds of (single source) biomass material may be employed to produce the lightweight rapidly biodegradable hanger 10.

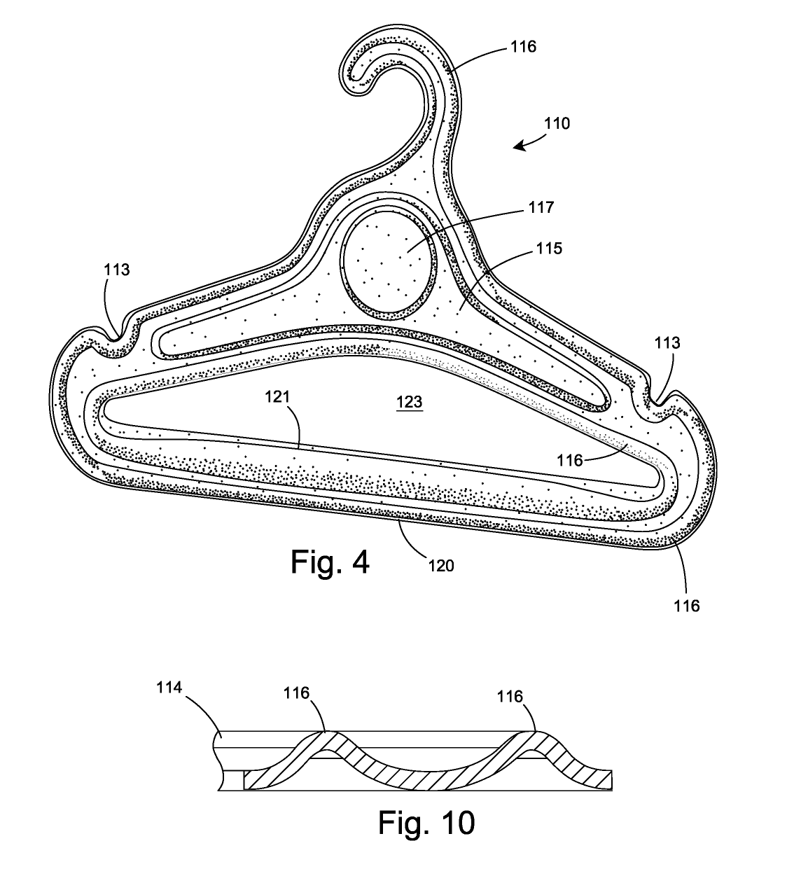

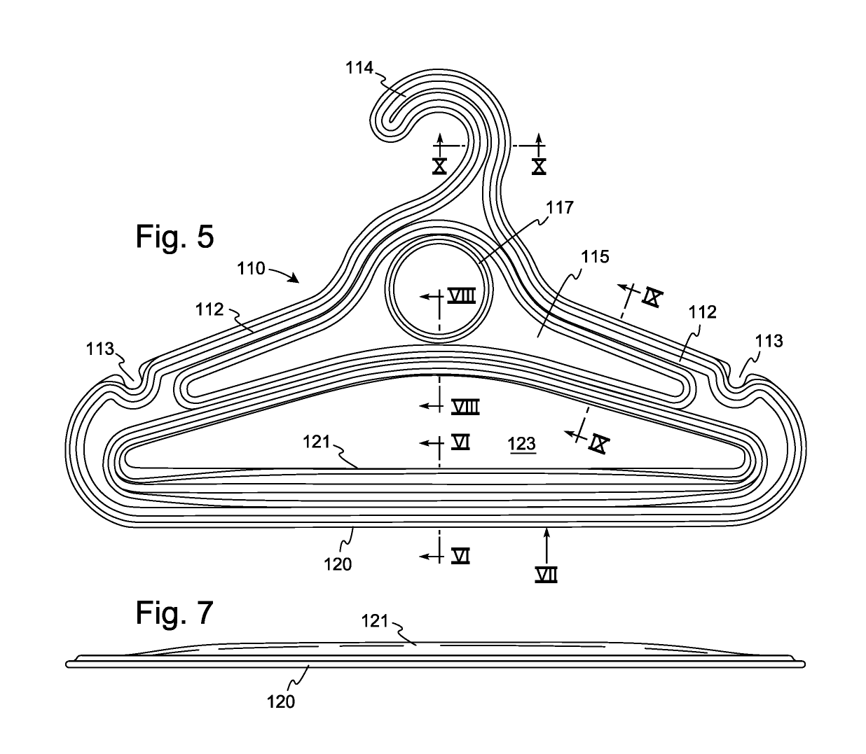

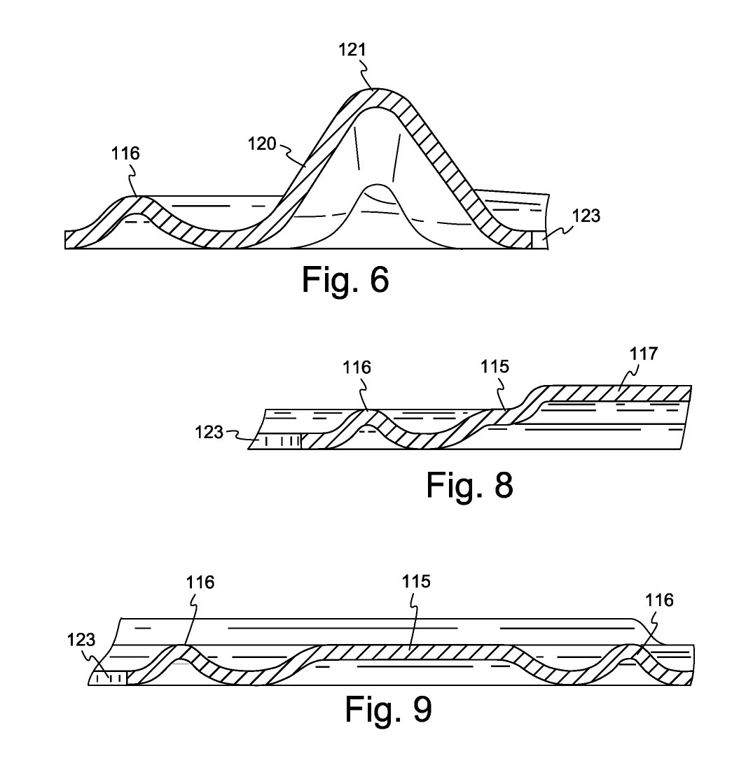

The lightweight, rapidly biodegradable garment hanger 110 of FIGS. 4 to 10 is produced by an identical wet thermoforming process as that employed to produce the hanger of FIGS. 1 to 3, employing the same bagasse or EFB start material. As before, the wet thermoforming process is characterized by simultaneous vacuum extraction and pressure expression of the material's moisture content whilst heating and drying the material in the foraminously walled mold. The hanger 110 produced is likewise lightweight and rapidly biodegradable with a mono-layer thickness less than 1.5 mm (preferably 1 mm to 1.5 mm). However, the appearance and mono-layer structure of hanger 110 differs in that an integral cross-bar 120 extends between the lower ends of the two inclined arms 112 (provided with indents 113) that depend from the hanging element provided by the hook 114. This integral cross-bar has a ridge-like upper edge 121 of somewhat bowed form being wider and higher centrally of the hanger than adjacent to the hanger's arms 112. This shaped edge 121 of cross-bar 120 serves to minimize creasing of trousers draped over the cross-bar 120. A reinforcing ridge 116 (of lesser width and height than the ridge-like edge 121) is molded to follow around the outer perimeter of hanger 110 spaced 2 to 3 mm therefrom and also at a similar spacing around the inner perimeter of the generally triangular aperture 123 provided between hanger arms 112 and cross-bar 120. In addition, a further reinforcing promontory 115 of generally triangular shape is provided between aperture 123 and hanging element 114, and an additional reinforcing promontory 117 of circular shape surmounts the promontory 115. Nonetheless, none of the projecting features 121, 115-117 interferes with stacking of a plurality of hangers 110 in surfacial abutment one upon the other.

Other modifications and embodiments of the invention, which will be readily apparent to those skilled in this art, are to be deemed within the ambit and scope of the invention, and the particular embodiment(s) hereinbefore described may be varied in construction and detail, e.g. interchanging (where appropriate or desired) different features of each, without departing from the scope of the patent monopoly hereby sought.

What is claimed is:

1. A molded lightweight and rapidly biodegradable garment hanger having the form of a generally planar unitary item with a hook or eye integral with a pair of hanger arms, said hanger being composed of a single constituent material that is either bagasse or empty palm tree fruit bunches (EFB) that has been subjected to wet process thermoforming by which the material's moisture content has been expressed whilst the material is being dried, said process providing the molded hanger with an overall thickness of the thermoformed material less than 1.5 mm in the range 1 mm to 1.5 mm, said garment hanger having a re-inforcing ridge adjacent to the perimeter of the finished hanger which ridge is provided by an integral deformation formed by said wet process thermoforming and which permits stacking of a plurality of said hangers one upon the other in mutual surfacial abutment.

2. A garment hanger according to claim 1 and devoid of any re-inforcing or protective coating detracting from its compostability.

3. A garment hanger according to claim 1, wherein the hanger has an overall weight of the order of 25 g to 35 g.

4. A garment hanger according to claim 1, wherein the thermoformed material has an overall thickness is in the range 1 mm to 1.5 mm.

5. A method of manufacturing a lightweight and rapidly biodegradable garment hanger wherein:
a body of either bagasse material or empty palm tree fruit bunches (EFB) material is placed in a mold having a cavity in the form of a hanger with a hook or eye integral and generally coplanar with a pair of hanger arms;
said mold is provided with mating parts comprising at least one depression and projection to produce an elongate deformation adjacent to the perimeter of the finished hanger which deformation serves as a reinforcing ridge; and
wherein said material is subjected to wet process thermoforming by which the material's moisture content is expressed whilst the material is being dried, to provide said lightweight and rapidly biodegradable hanger with an overall thickness less than 1.5 mm and a shape permitting stacking of a plurality of said hangers one upon the other in mutual surfacial abutment.

6. A method according to claim 5 wherein said overall thickness is in the range 1 mm to 1.5 mm.

7. A method according to claim 5 wherein the finished hanger has an overall weight of the order of 25 g to 35 g.

8. A method according to claim 5 wherein the body of bagasse or EFB material initially comprises water and pulp mixture in a ratio of 99.5% water and 0.5% pulp.

9. A method according to claim 8, wherein the water has an initial temperature between 30° C. and 50° C.

10. A method according to claim 9 wherein said initial temperature is approximately 40° C.

11. A method according to claim 5, wherein a pressure applied to the material in the mold is between 3.5 Kg/cm (50 psi) and 10.6 Kg/cm (150 psi).

12. A method according to claim 5, wherein the thermoforming takes place at a temperature is in the range of 250° C. to 300° C. approximately.

13. A method according to claim 5, wherein water is extracted from the mold by a vacuum.

14. A method according to claim 13 wherein said vacuum is between 610 mmHg and 710 mmHg.

15. A method according to claim 5, wherein said mold comprises a foraminous wall through which said moisture content is expressed.

16. A method according to claim 15, wherein said foraminous wall comprises a fine mesh material.
